(19) United States
(12) Patent Application Publication
(10) Pub. No.: US 2008/0287323 A1
(43) Pub. Date: Nov. 20, 2008

(54) Treatment and Reuse of Oilfield Produced Water

(76) Inventors: Leiming Li, Sugar Land, TX (US); Paul R. Howard, Sugar Land, TX (US); Michael D. Parris, Richmond, TX (US); Bernhard Lungwitz, Vernal, UT (US); Curtis L. Boney, Houston, TX (US); Kevin W. England, Houston, TX (US); Richard D. Hutchins, Sugar Land, TX (US); Jack Li, Sugar Land, TX (US)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 11/749,193

(22) Filed: May 16, 2007

(51) Int. Cl. C09K 8/68

(52) U.S. Cl. 507/211; 507/260; 507/271

(57) ABSTRACT

The invention discloses treatment and reuse of oilfield produced water. A method of inhibiting enzymes/bacteria in an aqueous medium for viscosification comprises contacting the aqueous medium with a denaturant and/or a bactericide and thereafter mixing a gelling agent in the aqueous medium. The viscosified fluid can be used as a well treating fluid for fracturing and other applications. A well treatment fluid comprises a metal denaturant and/or a bactericide and a gelling agent in an amount effective to viscosify the fluid. Also disclosed is oilfield produced water denatured with from 1 to 2000 ppm by weight of a zirconium compound.

### FIELD OF THE INVENTION

The invention relates to the treatment and reuse of water produced from a subterranean petroleum reservoir.

### BACKGROUND

It is costly to clean up oilfield produced water, e.g., water produced from a wellbore along with oil and/or gas or otherwise from or in contact with a subterranean petroleum reservoir, for proper treatment for acceptable environmental disposal. On the other hand, sources of fresh water for oilfield treatment processes such as water flooding, subterranean fracturing, etc., can represent a significant expense. Applicants recognized that there is a potential cost savings to be realized by cost-efficiently treating oilfield produced water on-site and then reusing the treated water, for example, to prepare fracturing or other well treatment fluids. The potential cost reduction is at least two-fold: first, there is less cost to dispose of produced water; second, the net amount of fresh water required to be imported for making treatment fluids is reduced or eliminated.

Many commercial fracturing fluids are aqueous based gels or foams. When the fluids are gelled, a viscoelastic surfactant system or a polymeric gelling agent, such as a soluble polysaccharide, can be used. The thickened or gelled fluid helps keep the proppants within the well treatment fluid. Gelling with polymers can be accomplished or improved by the use of crosslinking agents, or crosslinkers, that promote crosslinking, thereby increasing the viscosity of the fluid. U.S. Pat. No. 5,217,632 to Sharif, for example, discloses a synergy between boron and zirconium compounds used as a crosslinking agent for polysaccharides in the same fluid for better stability in the presence of acids, bases, boiling, high dilution and/or aging.

Following placement of a proppant or gravel pack with the viscosified fluid, the hydraulic conductivity of the fracture and the adjacent formation can be established by reducing the viscosity of the fracturing fluid to a low value so that it may flow naturally from the formation under the influence of formation fluids. Crosslinked gels and VES systems typically rely on viscosity breakers to initiate and/or accelerate the reduction of viscosity or “break” the gel. Bacteria-based and enzyme-based mechanisms as disclosed in U.S. Pat. No. 7,052,901 to Crews, for example, are known polymer viscosity breakers.

Unfortunately, when oilfield produced water was used “as is” to prepare fracturing fluids, applicants found that the viscosity of the fluids thus prepared usually quickly deteriorated in much the same manner as if a viscosity breaker had been prematurely activated in the fluid. Through a number of control experiments, applicants identified likely causes of the fluid failure as the degradation of polysaccharide or polysaccharide derivatives by bacteria and/or related enzymes present in the produced water. However, bactericides used at typical, antimicrobially effective concentrations were found to have little or no effect on improving the viscosification of the fluid. There is thus an unfulfilled need in the art for a cost-effective treatment of oilfield produced water so that the water can be used in the preparation of otherwise conventional viscosified fracturing and other well treatment fluids without premature loss of viscosity when employing standard gelling agents.

### SUMMARY OF THE INVENTION

We have found that oilfield produced water may contain microorganisms, related enzymes, or both, that can lead to premature fluid viscosity loss when the water is reused in viscosified fluids, e.g., well treatment fluids such as fracturing fluids in one embodiment. Water containing the microorganisms and/or enzymes can be pretreated with a denaturant to at least temporarily inactivate the microorganisms and/or enzymes. Thereafter, the denatured water can be used to prepare a viscosified fluid for a well treatment procedure without loss of viscosity, and without loss of conductivity in the case of a fracturing fluid.

One embodiment of the invention provides a method of inhibiting enzymes in an aqueous medium for viscosification. The method can include contacting the aqueous medium with a denaturant including a metal, and thereafter mixing a gelling agent in the aqueous medium to form a viscosified fluid. In an embodiment, the aqueous medium can include oilfield produced water. In an embodiment, the metal can include a heavy metal compound at least slightly soluble in the produced water. In an embodiment, the heavy metal can include zirconium. In another embodiment, the contact can include admixing the zirconium compound in the aqueous medium at a concentration from 1 to 2000 ppm by weight of the aqueous medium or, in an embodiment, at a concentration from 5 to 500 ppm by weight of the aqueous medium.

In an embodiment, the metal can include an inorganic zirconium compound. In an embodiment, the inorganic zirconium compound can be selected from the group consisting of zirconium nitrate, zirconyl chloride, zirconium phosphate, zirconium potassium chloride, zirconium potassium fluoride, zirconium potassium sulfate, zirconium pyrophosphate, zirconium sulfate, zirconium tetrachloride, zirconium tetrafluoride, zirconium tetrabromide, zirconium tetraiodide, zirconyl carbonate, zirconyl hydroxynitrate, zirconyl sulfate, and the like, and also including any hydrates thereof and combinations thereof. In another embodiment, the mixing can be within 0.5 to 120 hours of the contacting. In another embodiment, the aqueous medium can be free of detectable sulfide.

In an embodiment, the metal can include an organo-zirconium compound. In an embodiment, the organo-zirconium compound can be selected from the group consisting of zirconium acetate, zirconyl acetate, zirconium acetylacetonate, zirconium glycolate, zirconium lactate, zirconium naphthenate, sodium zirconium lactate, triethanolamine zirconium, zirconium propionate, and the like, and also including any hydrates thereof and combinations thereof. In another embodiment, the mixing can be within 2 to 72 hours of the contacting. In another embodiment, the aqueous medium can include detectable sulfide.

In an embodiment, the denaturant can further comprise a bactericide. In another embodiment, the denaturant can include both a bactericide and a zirconium compound. In this embodiment, the mixing can be within 0.5 to 120 hours of the contacting. In an embodiment, the denaturant can include an inorganic zirconium compound in combination with an organo-zirconium compound, and in another embodiment, a bactericide as well. In these embodiments, the mixing can be within 0.5 to 120 hours of the contacting.

In an embodiment, the gelling agent can include a viscoelastic surfactant system. In an embodiment, the gelling agent can include a polysaccharide, which in another embodiment, can be crosslinked. Another embodiment can include injecting the viscosified fluid into a subterranean formation adjacent a well bore. A further embodiment can include breaking the injected fluid and producing fluid from the formation through the well bore. In an embodiment, the viscosified fluid can further include proppant and the injection can form a conductive fracture in the formation held open by the proppant.

Another embodiment of the invention provides a well treating fluid. In one embodiment the well treating fluid can include the viscosified fluid produced from the method discussed above. In another embodiment, the well treating fluid can include oilfield produced water, a denaturant including a metal compound, and a gelling agent in an amount effective to viscosity the fluid. In an embodiment, the metal can include zirconium. In an embodiment, the zirconium compound can be present in the fluid at a concentration from 1 to 2000 ppm by weight of the fluid or, in another embodiment, at from 5 to 500 ppm by weight.

In an embodiment of the well treating fluid, the metal compound can include inorganic zirconium. In an embodiment, the metal compound can be selected from the group consisting of zirconium nitrate, zirconyl chloride, zirconium phosphate, zirconium potassium chloride, zirconium potassium fluoride, zirconium potassium sulfate, zirconium pyrophosphate, zirconium sulfate, zirconium tetrachloride, zirconium tetrafluoride, zirconium tetrabromide, zirconium tetraiodide, zirconyl carbonate, zirconyl hydroxynitrate, zirconyl sulfate, and the like, and also including any hydrates thereof and combinations thereof.

In one embodiment of the well treating fluid the metal compound can include organo-zirconium. In an embodiment, the metal compound is selected from the group consisting of zirconium acetate, zirconyl acetate, zirconium acetylacetonate, zirconium glycolate, zirconium lactate, zirconium naphthenate, sodium zirconium lactate, triethanolamine zirconium, zirconium propionate, and the like, and also including any hydrates thereof and combinations thereof.

In another embodiment of the well treating fluid, the metal compound can include a combination of an inorganic zirconium compound and an organo-zirconium compound. In another embodiment, the treatment can include a bactericide.

In an embodiment of the well treating fluid, the gelling agent can include a viscoelastic surfactant system. In an embodiment, the gelling agent can include a polysaccharide, which in another embodiment, can be crosslinked. An embodiment of the well treating fluid further includes proppant. Another embodiment further includes a delayed breaker.

In an embodiment, the well treating fluid further comprises an ability to retain a conductivity of a proppant pack and fracture which is on par with the ability of a similar fluid prepared with fresh water to retain the conductivity.

Another embodiment of the invention provides oilfield produced water denatured with from 1 to 2000 ppm or, in an embodiment, from 5 to 500 ppm, by weight of a zirconium compound. An embodiment can further include a bactericide.

In an embodiment of the oilfield produced water, the zirconium compound can include inorganic zirconium. In an embodiment, the zirconium compound is selected from the group consisting of zirconium nitrate, zirconyl chloride, zirconium phosphate, zirconium potassium chloride, zirconium potassium fluoride, zirconium potassium sulfate, zirconium pyrophosphate, zirconium sulfate, zirconium tetrachloride, zirconium tetrafluoride, zirconium tetrabromide, zirconium tetraiodide, zirconyl carbonate, zirconyl hydroxynitrate, zirconyl sulfate, and the like, and also including any hydrates thereof and combinations thereof.

In an embodiment of the oilfield produced water, the zirconium compound can include organo-zirconium. An embodiment can further include a bactericide. Another embodiment can include detectable sulfide. In an embodiment, the zirconium compound can be selected from the group consisting of zirconium acetate, zirconyl acetate, zirconium acetylacetonate, zirconium glycolate, zirconium lactate, zirconium naphthenate, sodium zirconium lactate, triethanolamine zirconium, zirconium propionate, and the like, and also including any hydrates thereof and combinations thereof.

In an embodiment of the oilfield produced water, the zirconium compound can include a mixture of an inorganic zirconium compound and an organo-zirconium compound, and in another embodiment, a bactericide as well.

### BRIEF DESCRIPTION OF THE DRAWINGS

FIG. 1 is a viscosity profile of a fluid comprising borate-crosslinked guar in 2% KCl made using deionized water (ES1), showing the viscosity failure caused by the presence of hemicellulase enzyme breaker (ES2), and the disabling of the enzyme by treatment with zirconium acetate (ES3), according to an embodiment of the invention.

FIG. 2 shows viscosity profiles of gel comprising borate-crosslinked guar made with produced water (PW4, as is), and with produced water pretreated with zirconyl chloride (ES4), showing the disabling of bacteria and/or enzymes by the pretreatment according to an embodiment of the invention.

FIG. 3 shows viscosity profiles of gel comprising borate-crosslinked guar made with produced water (PW5-1, as is), and with produced water pretreated with zirconium tetrachloride (ZTC) (ES5), showing the disabling of bacteria and/or enzymes by the pretreatment according to an embodiment of the invention.

FIG. 4 shows viscosity profiles of gel comprising borate-crosslinked guar made with produced water (PW6-1, as is), and with produced water pretreated with BaCl₂ (ES6 and ES7), showing pretreatment with barium ions had limited ability to disable bacteria and/or enzymes under the conditions evaluated.

FIG. 5 shows viscosity profiles of gel comprising borate-crosslinked guar made with produced water (PW4, as is), and with produced water pretreated with zirconium acetate (ES8), showing the disabling of bacteria and/or enzymes by the pretreatment according to an embodiment of the invention.

FIG. 6 shows viscosity profiles of gels comprising borate-crosslinked guar made with produced water (PW4, as is), and with produced water pretreated with triethanolamine zirconium M9 (ES9), sodium zirconium lactate solution M8 (ES10), or with pure sodium zirconium lactate (ES11), showing the disabling of bacteria and/or enzymes by the pretreatment according to embodiments of the invention.

FIG. 7 shows viscosity profiles at 79° C. of gels comprising borate-crosslinked guar made with produced water (PW6-2, as is) pretreated with 1 mL/L triethanolamine zirconium M9 (ES12), showing the disabling of bacteria and/or enzymes by the pretreatment according to an embodiment of the invention.

FIG. 8 shows viscosity profiles at 93° C. of gels comprising borate-crosslinked guar made with produced water (PW5-3, as is), and with produced water pretreated with 1 mL/L sodium zirconium lactate M8 (ES13), showing the disabling of bacteria and/or enzymes by the pretreatment according to an embodiment of the invention.

FIG. 9 shows viscosity profiles at 93° C. of gels comprising borate-crosslinked guar made with produced water (PW5-2, as is), and with produced water pretreated with 0.5 (ES14), 1 (ES15) or 2 (ES16) mL/L triethanolamine zirconium M9, showing the disabling of bacteria and/or enzymes by the pretreatment according to embodiments of the invention.

FIG. 10 shows viscosity profiles at 93° C. of an alternative gel formulation comprising borate-crosslinked guar with high pH made with produced water (PW4, as is), and with produced water pretreated with triethanolamine zirconium M9 (ES17), showing the disabling of bacteria and/or enzymes by the pretreatment according to another embodiment of the invention.

FIG. 11 shows viscosity profiles at 121 and 135° C. of gels comprising zirconium-crosslinked carboxy-methyl-hydroxy-propyl guar (CMHPG) made with produced water (PW4, as is), and with produced water pretreated with sodium zirconium lactate M8 (ES18), showing the disabling of bacteria and/or enzymes by the pretreatment according to an embodiment of the invention.

FIG. 12 shows viscosity profiles at 93° C. of gel comprising borate-crosslinked guar made with produced water (PW5-1, as is), and with produced water pretreated with triethanolamine titanate M3 (ES19), showing pretreatment with triethanolamine titanate M3 had limited ability to disable bacteria and/or enzymes under the conditions evaluated.

FIG. 13 shows viscosity profiles at 93° C. of gel comprising borate-crosslinked guar made with produced water (PW7-2, as is), produced water pretreated with bactericide M19 (ES20) or M20 only (ES22), and produced water treated with both bactericide and organo-zirconium (ES21 and ES23), showing the disabling of bacteria and/or enzymes by pretreatment with bactericide and organo-zirconium according to an embodiment of the invention.

FIG. 14 shows viscosity profiles at 93° C. of gels comprising borate-crosslinked guar with high pH made with produced water pretreated with bactericide M19 and 0.18 mL/L of an aqueous solution of zirconium oxychloride M14 (ES24) or 0.36 mL/L M14 (ES25), showing the disabling of bacteria and/or enzymes by the pretreatment according to an embodiment of the invention.

FIG. 15 shows viscosity profiles at 93° C. of gels comprising borate-crosslinked guar with high pH made with produced water pretreated with bactericide M19 and 1 mL/L of an aqueous solution of 13 wt % ZTC (ES26) or 0.5 mL/L of the aqueous solution of 13 wt % ZOC (ES27), showing the disabling of bacteria and/or enzymes by the pretreatment according to an embodiment of the invention.

### DETAILED DESCRIPTION

At the outset, it should be noted that in the development of any actual embodiments, numerous implementation-specific decisions must be made to achieve the developer's specific goals, such as compliance with system- and business-related constraints, which can vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating the preferred embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components other than the ones already cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range.

“Oilfield produced water” or simply “produced water” includes water that is produced with oil or gas, produced from petroleum-bearing subterranean strata, or otherwise contaminated with hydrocarbons in conjunction directly or indirectly with the production of subterranean fluids. As further representative examples in addition to production water per se there can also be mentioned flowback water, e.g. from a stimulation or workover treatment, reserve pit water, water circulated out of wellbore, and so on, including any combinations thereof.

The term “aqueous media” refers to any liquid system comprising water, optionally including dissolved solutes or dispersed or aggregated undissolved solids. An “aqueous solution” is a portion of water which includes dissolved solids, but which can further include undissolved solids. Reference to metals, metal compounds, denaturants or other materials associated with aqueous media shall be construed to encompass any dispersed, dissolved, chelated, hydrated, ionic, and dissociated forms of the metals, metal compounds, denaturants or other materials as they may exist in the aqueous media. For example, zirconium sulfate may form various hydrates and/or partially dissociate into ions in water, and the recitation of the term “zirconium sulfate” in the specification and claims is intended to encompass zirconium sulfate per se as well as any or all of the hydrates, ions, chelates, solutes or various other forms of zirconium sulfate.

An “organic compound” as used herein refers to compounds of, containing or relating to carbon, and especially carbon compounds that are or are potentially active in biological systems.

The term “heavy metal” used here refers to a metal or metalloid with a large atomic number (no strict and/or unique scientific definitions though). Examples of “heavy metals” include, but are not limited to zirconium, hafnium, chromium, zinc, copper, cadmium, lead, mercury, manganese, and so on.

The presence or absence of detectable sulfides in an aqueous medium such as oilfield produced water can be determined directly by smell or chemical analysis. Many people can smell hydrogen sulfide at concentrations in air at about 0.0047 ppm by volume. The sulfides can originate from the subsurface strata from which the water is produced, or from the action of exogenous sulfate-reducing bacteria if there is sulfate present in the produced water.

The present invention is applicable to the treatment and reuse of oilfield produced water in one embodiment, but in another embodiment is applicable generally to any water source that may be or become contaminated with enzymes and/or microorganisms such as bacteria that can interfere with the functionality of any fluid with an aqueous medium comprising the water source. For example, water in tanks, containers or reservoirs open or vented to the atmosphere may contain or acquire bacteria and/or bacteriological nutrients from endogenous and/or exogenous sources such as entrained or airborne organic matter.

The water is pretreated in one embodiment by contact with a denaturant that can include any metal that can function to denature or otherwise disable the enzymes and/or bacteria. In one embodiment, the metal is used in a form that can be at least slightly soluble in the aqueous medium, and in another embodiment is in a form that is soluble in water. In one embodiment, the water is treated by contact with the metal in a solid form, e.g., in a heterogeneous system. In another embodiment, the metal is soluble or slightly soluble at the conditions of contact, e.g., temperature, pH, ionic strength, presence of chelates, etc., to result in a homogenous treatment system.

In an embodiment, the metal can be a heavy metal compound, such as, for example, compounds of potassium, calcium, scandium, titanium, vanadium, chromium, manganese, iron, cobalt, nickel, copper, zinc, gallium, germanium, rubidium, strontium, yttrium, zirconium, niobium, molybdenum, technetium, rhodium, palladium, silver, gold, cadmium, indium, tin, antimony, cesium, barium, osmium, iridium, platinum, mercury, tantalum, lead, bismuth, polonium, any other transition elements, combinations thereof, and the like, which is capable of denaturing or otherwise disabling the enzymes and/or bacteria under conditions of treatment.

In a preferred but not exclusive embodiment, the heavy metal can be zirconium, which in embodiments can be an inorganic zirconium compound, an organic zirconium compound, or can include both inorganic zirconium and organo-zirconium. In an embodiment, the zirconium compound can be selected from the group consisting of zirconium nitrate, zirconyl chloride, zirconium phosphate, zirconium potassium chloride, zirconium potassium fluoride, zirconium potassium sulfate, zirconium pyrophosphate, zirconium sulfate, zirconium tetrachloride, zirconium tetrafluoride, zirconium tetrabromide, zirconium tetraiodide, zirconyl carbonate, zirconyl hydroxynitrate, zirconyl sulfate, zirconia hydrate, zirconium carbide, zirconium nitride, zirconium hydroxide, zirconium orthosilicate, zirconium tetrahydroxide, zirconium tungstate, and the like, and also including any hydrates thereof and combinations thereof. Inorganic zirconium compounds can be beneficial where quick-acting, long-duration treatment is desired.

In an embodiment, the metal can include an organo-zirconium compound. In an embodiment, the organo-zirconium compound can be selected from the group consisting of zirconium acetate, zirconyl acetate, zirconium acetylacetonate, zirconium glycolate, zirconium lactate, zirconium naphthenate, triethanolamine zirconium, zirconocene dihalides, and the like, and also including any hydrates thereof and combinations thereof. Sodium or potassium zirconium alpha hydroxyl carboxylates such as lactates, citrates, tartrates, glycolates, maleates, saccharates, gluconates, glycerates, mandelates and the like can also be mentioned. Organo-zirconium compounds can be beneficial where the presence or possible presence of sulfide or similar anions may otherwise precipitate or inactivate inorganic zirconium compounds.

The organo-zirconium compound may also be zirconium complexed with alpha or beta amino acids, phosphonic acids, salts and derivatives thereof. The ratio of metal to ligand in the complex can range from 1:1 to 1:4. Preferably the ratio metal to ligand can range from 1:1 to 1:6. More preferably the ratio metal to ligand can range from 1:1 to 1:4. Those complexes can be used to crosslink the hydratable polymers. The following acids and their salts were found to be useful ligands: alanine, arginine, asparagines, aspartic acid, cysteine, glutamic acid, glutamine, glycine, histidine, isoleucine, leucine, lysine, methyonine, phenyl alanine, praline, serine, threonine, tryptophan, tyrosine, valine, carnitine, ornithine, taurine, citrulline, glutathione, hydroxyproline. The following acids and their salts were found to be suitable ligands: DL-Glutamic acid, L-Glutamic acid, D-Glutamic acid, DL-Aspartic acid, D-Aspartic acid, L-Aspartic acid, beta-alanine, DL-alanine, D-alanine, L-alanine, Phosphonoacetic acid. Zirconium IV was found to be preferred metal to form complexes with various alpha or beta amino acids, phosphonic acids and derivatives thereof.

In one embodiment, the organo-zirconium compound comprises zirconium complexed with a beta-diketone compound and an alkoxy group having a branched alkyl group according to the following formula (I):

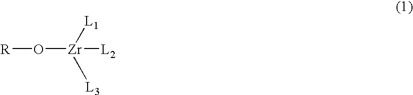

wherein R is a branched alkyl group having 4 or 5 carbons; and L1, L2, and L3, are the same or different from each other and are each a beta-diketone compound.

The denaturant in an embodiment can also include a bactericidally effective amount of a bactericide. The bactericide in one embodiment is an organic bactericide that inhibits the growth of bacteria in the aqueous medium, or at least suppresses the expression of enzymes, but may not be effective to denature the enzymes. The bactericide can be beneficial in an embodiment where the metal compound is not effective to kill or prevent the growth of bacteria in the amount employed, or where the metal compound and the bactericide have a synergistic effect in either or both the denaturing of enzymes or the destruction of bacteria. Representative examples of bactericides include glutaraldehyde, tetrakishydroxymethyl phosphonium sulfate, and the like.

The type and amount of denaturant used to treat the produced water depends on several factors, such as, but not exclusively limited to, the nature and extent of enzyme/bacteria in the water, the presence of species that might adversely react with the denaturant, and the type of system in which the treated water will be used. For example, the denaturant system could include zirconium compounds that, if employed in excessive amounts, might have a possibly adverse effect on polymer gelation, e.g., a resulting fluid of many small gel domains with low viscosity. If the zirconium has not been allowed to sufficiently interact with the bacteria and/or enzyme, it can interact with, for example, borate crosslinkers. In one embodiment, a zirconium compound is used in an amount from 1 ppm or less up to 2000 ppm or more, by weight of the zirconium compound in the aqueous medium. In an embodiment, the denaturant includes an organo-zirconium compound if sulfide is or may be present in the system. For example, in embodiments where sulfate-reducing bacteria may be or may become present, the organo-zirconium compound can be employed if the sulfate concentration in the water is more than 200, 400, 800 or 1600 ppm by weight. On the other hand, in another embodiment inorganic zirconium compounds can be used as the sole denaturant where sulfide might be present or formed only in amounts insufficient to inactivate them, for example where sulfate reducing bacteria may be or become present in embodiments where the sulfate concentration is less than 1600, 800, 400 or 200 ppm by weight.

In an embodiment, the mixing of the viscosification system with the treated water can occur after a period of time sufficient to allow the denaturant to inactivate the enzymes and/or bacteria, and before the treatment begins to have diminished effectiveness. If the mixing step occurs too soon, the enzymes may still be sufficiently active to adversely affect the viscosification system, or the raw denaturant may adversely affect viscosification unless it is allowed to equilibrate or be fully “consumed” by the enzymes and/or bacteria. In embodiments, 0.5, 1 or 2 hours can be a suitable minimum period for the denaturant to effectively treat the produced water, whereas 2, 3, 4 or 5 days can be a suitable maximum period before the enzymatic and/or bacteriological system may be able to use up or overwhelm the denaturant and re-establish to interfere with the viscosification system. In an embodiment employing an inorganic zirconium compound the treatment window can be as little as 0.5 hours to 3 days or more. In an embodiment employing an organic zirconium compound the treatment window can be as little as 2 hours to 5 days or more. In embodiments employing a combination of an inorganic zirconium compound and an organic zirconium compound, or a combination of an inorganic zirconium compound, an organic zirconium compound, and a bactericide, the treatment window can be as little as 0.5 hours to 5 days or more.

The treated water can be reused in a well treatment fluid in various conventional applications without deleterious consequences or fluid failure. Embodiments include hydraulic fracturing fluids, gravel packs, water conformance control, acid fracturing, waterflood, drilling fluids, wellbore cleanout fluids, fluid loss control fluids, kill fluids, spacers, flushes, pushers, and carriers for materials such as scale, paraffin, and asphaltene inhibitors, and the like. Viscosification systems can include polymers, including crosslinked polymers, viscoelastic surfactant systems (VES), fiber viscosification systems, mixed fiber-polymer and fiber-VES systems, slickwater (low viscosity) systems, and so on.

The present invention is discussed herein with specific reference to the embodiment of hydraulic fracturing, but it is also suitable for gravel packing, or for fracturing and gravel packing in one operation (called, for example frac and pack, frac-n-pack, frac-pack, StimPac treatments, or other names), which are also used extensively to stimulate the production of hydrocarbons, water and other fluids from subterranean formations. These operations involve pumping a slurry of “proppant” (natural or synthetic materials that prop open a fracture after it is created) in hydraulic fracturing or “gravel” in gravel packing. In low permeability formations, the goal of hydraulic fracturing is generally to form long, high surface area fractures that greatly increase the magnitude of the pathway of fluid flow from the formation to the wellbore.

In high permeability formations, the goal of a hydraulic fracturing treatment is typically to create a short, wide, highly conductive fracture, in order to bypass near-wellbore damage done in drilling and/or completion, to ensure good fluid communication between the rock and the wellbore and also to increase the surface area available for fluids to flow into the wellbore.

Gravel is also a natural or synthetic material, which may be identical to, or different from, proppant. Gravel packing is used for “sand” control. Sand is the name given to any particulate material from the formation, such as clays, that could be carried into production equipment. Gravel packing is a sand-control method used to prevent production of formation sand, in which, for example a steel screen is placed in the wellbore and the surrounding annulus is packed with prepared gravel of a specific size designed to prevent the passage of formation sand that could foul subterranean or surface equipment and reduce flows. The primary objective of gravel packing is to stabilize the formation while causing minimal impairment to well productivity. Sometimes gravel packing is done without a screen. High permeability formations are frequently poorly consolidated, so that sand control is needed; they may also be damaged, so that fracturing is also needed. Therefore, hydraulic fracturing treatments in which short, wide fractures are wanted are often combined in a single continuous (“frac and pack”) operation with gravel packing. For simplicity, in the following we may refer to any one of hydraulic fracturing, fracturing and gravel packing in one operation (frac and pack), or gravel packing, and mean them all.

The treatment fluid based on the reused water according to an embodiment of the present invention is beneficial in embodiments where the viscosity of the viscosified treatment fluid is at least 3, 50, 100, 150, or 200 cP at 25° C., and especially where the treatment fluid is maintained at elevated temperatures without viscosity failure for 30, 60, 90 or 180 minutes or more. Embodiments of polymer viscosifiers include, for example, polysaccharides such as substituted galactomannans, such as guar gums, high-molecular weight polysaccharides composed of mannose and galactose sugars, or guar derivatives such as hydroxypropyl guar (HPG), carboxymethylhydroxypropyl guar (CMHPG) and carboxymethyl guar (CMG), hydrophobically modified guars, guar-containing compounds, and synthetic polymers. Crosslinking agents based on boron, titanium, zirconium or aluminum complexes are typically used to increase the effective molecular weight of the polymer and make them better suited for use in high-temperature wells.

Other embodiments of effective water-soluble polymers (provided that specific examples chosen are compatible with the denaturants of the invention) include polyvinyl polymers, polymethacrylamides, cellulose ethers, lignosulfonates, and ammonium, alkali metal, and alkaline earth salts thereof. More specific examples of other typical water soluble polymers are acrylic acid-acrylamide copolymers, acrylic acid-methacrylamide copolymers, polyacrylamides, partially hydrolyzed polyacrylamides, partially hydrolyzed polymethacrylamides, polyvinyl alcohol, polyvinyl acetate, polyalkyleneoxides, carboxycelluloses, carboxyalkylhydroxyethyl celluloses, hydroxyethylcellulose, other galactomannans, heteropolysaccharides obtained by the fermentation of starch-derived sugar (e.g., xanthan gum), and ammonium and alkali metal salts thereof.

Cellulose derivatives are also used in an embodiment, such as hydroxyethylcellulose (HEC) or hydroxypropylcellulose (HPC), carboxymethylhydroxyethylcellulose (CMHEC) and carboxymethycellulose (CMC), with or without crosslinkers. Xanthan, diutan, and scleroglucan, three biopolymers, have been shown to have excellent proppant-suspension ability even though they are more expensive than guar derivatives and therefore have been used less frequently unless they can be used at lower concentrations.

Linear (not cross-linked) polymer systems can be used in another embodiment, but generally require more polymer for the same level of viscosification. All crosslinked polymer systems may be used, including for example delayed, optimized for high temperature, optimized for use with sea water, buffered at various pH's, and optimized for low temperature. Any crosslinker may be used, for example boron, titanium, and zirconium. Suitable boron crosslinked polymers systems include by non-limiting example, guar and substituted guars crosslinked with boric acid, sodium tetraborate, and encapsulated borates; borate crosslinkers may be used with buffers and pH control agents such as sodium hydroxide, magnesium oxide, sodium sesquicarbonate, and sodium carbonate, amines (such as hydroxyalkyl amines, anilines, pyridines, pyrimidines, quinolines, and pyrrolidines, and carboxylates such as acetates and oxalates) and with delay agents such as sorbitol, aldehydes, and sodium gluconate. Suitable zirconium crosslinked polymer systems include by non-limiting example, those crosslinked by zirconium lactates (for example sodium zirconium lactate), triethanolamines, 2,2′-iminodiethanol, and with mixtures of these ligands, including when adjusted with bicarbonate. Suitable titanates include by non-limiting example, lactates and triethanolamines, and mixtures, for example delayed with hydroxyacetic acid. Any other chemical additives can be used or included provided that they are tested for compatibility with the fibers and fiber degradation products of the invention (neither the fibers or their degradation products or the chemicals in the fluids interfere with the efficacy of one another or with fluids that might be encountered during the job, like connate water or flushes). For example, some of the standard crosslinkers or polymers as concentrates usually contain materials such as isopropanol, n-propanol, methanol or diesel oil.

As mentioned, viscoelastic surfactant fluid systems (such as cationic, amphoteric, anionic, nonionic, mixed, and zwitterionic viscoelastic surfactant fluid systems, especially betaine zwitterionic viscoelastic surfactant fluid systems or amidoamine oxide surfactant fluid systems) may be also used provided that they are tested for compatibility with the denaturant and denaturant degradation products of the invention. Non-limiting examples include those described in U.S. Pat. Nos. 5,551,516; 5,964,295; 5,979,555; 5,979,557; 6,140,277; 6,258,859 and 6,509,301, all hereby incorporated by reference. The solid acid/pH control agent combination of this invention has been found to be particularly useful when used with several types of zwitterionic surfactants. In general, suitable zwitterionic surfactants have the formula:

RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻

in which R is an alkyl group that contains from about 17 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to about 10 if m is 0; a′ and b′ are each 1 or 2 when m′ is not 0 and (a′+b′) is from 1 to about 5 if m is 0; (m+m′) is from 0 to about 14; and CH₂CH₂O may also be oriented as OCH₂CH₂. Preferred surfactants are betaines.

Two examples of commercially available betaine concentrates are, respectively, BET-O-30 and BET-E-40. The VES surfactant in BET-O-30 is oleylamidopropyl betaine. It is designated BET-O-30 because as obtained from the supplier (Rhodia, Inc. Cranbury, N.J., U.S.A.) it is called Mirataine BET-O-30; it contains an oleyl acid amide group (including a C₁₇H₃₃ alkene tail group) and is supplied as about 30% active surfactant; the remainder is substantially water, sodium chloride, glycerol and propane-1,2-diol. An analogous suitable material, BET-E-40, was used in the experiments described above; one chemical name is erucylamidopropyl betaine. BET surfactants, and others that are suitable, are described in U.S. Pat. No. 6,258,859. Certain co-surfactants may be useful in extending the brine tolerance, to increase the gel strength, and to reduce the shear sensitivity of VES fluids, in particular for BET-O-type surfactants. An example given in U.S. Pat. No. 6,258,859 is sodium dodecylbenzene sulfonate (SDBS). VES's may be used with or without this type of co-surfactant, for example those having a SDBS-like structure having a saturated or unsaturated, branched or straight-chained C₆ to C₁₆ chain; further examples of this type of co-surfactant are those having a saturated or unsaturated, branched or straight-chained C₈ to C₁₆ chain. Other suitable examples of this type of co-surfactant, especially for BET-O-30, are certain chelating agents such as trisodium hydroxyethylethylenediamine triacetate.

In another embodiment, suitable fibers can assist in transporting, suspending and placing proppant in hydraulic fracturing and gravel packing and can optionally also degrade to minimize or eliminate the presence of fibers in the proppant pack without releasing degradation products that either a) react with certain multivalent ions present in the fracture water or gravel packing carrier fluid, or formation water to produce materials that hinder fluid flow, or b) decrease the ability of otherwise suitable metal-crosslinked polymers to viscosify the carrier fluid. Systems in which fibers and a fluid viscosified with a suitable metal-crosslinked polymer system or with a VES system are known to the skilled artisan to slurry and transport proppant as a “fiber assisted transport” system, “fiber/polymeric viscosifier” system or an “FPV” system, or “fiber/VES” system. Most commonly the fiber is mixed with a slurry of proppant in crosslinked polymer fluid in the same way and with the same equipment as is used for fibers used for sand control and for prevention of proppant flowback, for example, but not limited to, the method described in U.S. Pat. No. 5,667,012. In fracturing, for proppant transport, suspension, and placement, the fibers are normally used with proppant or gravel laden fluids, not normally with pads, flushes or the like.

Any conventional proppant (gravel) can be used. Such proppants (gravels) can be natural or synthetic (including but not limited to glass beads, ceramic beads, sand, and bauxite), coated, or contain chemicals; more than one can be used sequentially or in mixtures of different sizes or different materials. The proppant may be resin coated, preferably pre-cured resin coated, provided that the resin and any other chemicals that might be released from the coating or come in contact with the other chemicals of the Invention are compatible with them. Proppants and gravels in the same or different wells or treatments can be the same material and/or the same size as one another and the term “proppant” is intended to include gravel in this discussion. In general the proppant used will have an average particle size of from about 0.15 mm to about 2.39 mm (about 8 to about 100 U.S. mesh), more particularly, but not limited to 0.25 to 0.43 mm (40/60 mesh), 0.43 to 0.84 mm (20/40 mesh), 0.84 to 1.19 mm (16/20), 0.84 to 1.68 mm (12/20 mesh) and 0.84 to 2.39 mm (8/20 mesh) sized materials. Normally the proppant will be present in the slurry in a concentration of from about 0.12 to about 0.96 kg/L, preferably from about 0.12 to about 0.72 kg/L, preferably from about 0.12 to about 0.54 kg/L. The viscosified proppant slurry can be designed for either homogeneous or heterogeneous proppant placement in the fracture, as known in the art.

Also optionally, the fracturing fluid can contain materials designed to limit proppant flowback after the fracturing operation is complete by forming a porous pack in the fracture zone. Such materials can be any known in the art, such as fibers, such as glass fibers, available from Schlumberger under the trade name PropNET™ (for example see U.S. Pat. No. 5,501,275). Exemplary proppant flowback inhibitors include fibers or platelets of novoloid or novoloid-type polymers (U.S. Pat. No. 5,782,300). Thus the fracturing system may contain different or mixed fiber types, for example non-degradable or degradable only at a higher temperature, present primarily to aid in preventing proppant flowback. The system may also contain another fiber, such as a polyethylene terephthalate fiber, which is also optimized for assisting in transporting, suspending and placing proppant, but has a higher degradation temperature and would precipitate calcium and magnesium without preventive measures being taken. As has been mentioned, appropriate preventive measures may be taken with other fibers, such as, but not limited to, pumping a pre-pad and/or pumping an acid or a chelating dissolver, adsorbing or absorbing an appropriate chelating agent onto or into the fiber, or incorporating in the fluid precipitation inhibitors or metal scavenger ions that prevent precipitation.

Any additives normally used in such well treatment fluids can be included, again provided that they are compatible with the other components and the desired results of the treatment. Such additives can include, but are not limited to breakers, anti-oxidants, crosslinkers, corrosion inhibitors, delay agents, biocides, buffers, fluid loss additives, pH control agents, solid acids, solid acid precursors, etc. The wellbores treated can be vertical, deviated or horizontal. They can be completed with casing and perforations or open hole.

The pad and fracturing fluid can both be prepared using the zirconium treated produced water according to an embodiment of the invention. A pad and fracturing fluid are viscosified because increased viscosity results in formation of a wider fracture, thus a larger flowpath, and a minimal viscosity is required to transport adequate amounts of proppant; the actual viscosity required depends primarily upon the fluid flow rate and the density of the proppant. In a typical fracturing process, such as hydraulic fracturing with aqueous fluids, the fracture is initiated by first pumping a high viscosity aqueous fluid with good to moderate leak-off properties, and typically no proppant, into the formation. This pad is usually followed by a carrier fluid of similar viscosity carrying an initially low concentration and then a gradually increasing concentration of proppant into the extended fractures. The pad initiates and propagates the fracture but does not need to carry proppant. All the fluids tend to “leak-off” into the formation from the fracture being created. Commonly, by the end of the job the entire volume of the pad will have leaked off into the formation. This leak-off is determined and controlled by the properties of the fluid (and additives it may contain) and the properties of the rock. A certain amount of leak-off greater than the minimal possible may be desirable, for example a) if the intention is to place some fluid in the rock to change the rock properties or to flow back into the fracture during closure, or b) if the intention is deliberately to cause what is called a “tip screen-out”, or “TSO”, a condition in which the proppant forms a bridge at the end of the fracture, stopping the lengthening of the fracture and resulting in a subsequent increase in the fracture width. On the other hand, excessive leak-off is undesirable because it may waste valuable fluid and result in reduced efficiency of the job. Proper leak-off control is therefore critical to job success.

### EXAMPLES

The following examples use the following materials, which are identified as follows:

M1=a slurried guar comprising 30-60 wt % guar gum in 30-60 wt % light petroleum distillates

M2=an aqueous solution of about 50 wt % hemicellulase enzyme breaker

M3=a 80 wt % isopropanol solution of triethanolamine titanate crosslinker

M4=granulated sodium thiosulfate pentahydrate

M5=a 30 wt % aqueous solution of sodium thiosulfate

M6=encapsulated ammonium persulfate breaker

M7=d-sorbitol

M8=an aqueous solution of 23 wt % sodium zirconium lactate

M9=an aqueous solution of zirconium triethanolamine complex

M10=an aqueous solution of borate crosslinker containing 10-20 wt % sodium tetraborate decahydrate

M11=a blend of surfactant and clay stabilizer containing 36 wt % tetramethyl ammonium chloride

M12=a slurriable carboxymethylhydroxypropyl guar (CMHPG)

M13=granular boric acid

M14=an aqueous solution of 20 wt % zirconium oxychloride

M15=an aqueous solution of 50 wt % tetramethyl ammonium chloride

M16=an aqueous solution of 14 wt % isopropanol and 74 wt % acetic acid

M17=an aqueous solution of 30 wt % sodium hydroxide

M18=a demulsifier containing a blend of surfactants

M19=a bactericide comprising 25 wt % glutaraldehyde and 75 wt % water

M20=a bactericide comprising 75 wt % tetrakishydroxymethyl phosphonium sulfate and 25 wt % water

M21=a borate crosslinker

Seven different batches of produced water were obtained from production operations in a North American oil/gas field. The ion species and respective concentrations for these water samples are listed in Table 1.

TABLE 1
Ion Concentrations in Produced Water Samples (mg/l).

| Produced | | | | | | | | | | | | |
|---|---|---|---|---|---|---|---|---|---|---|---|---|
| water | | | | | | | | | | | | |
| sample | Na | K | Ca | Mg | Ba | Fe | Al | Si | Cl⁻ | CO₃²⁻ | HCO₃⁻ | SO₄²⁻ |
| PW4 | 15900 | 36 | 738 | 36 | 0 | 0 | 0 | 0 | 24106 | 80 | 954 | <200 |
| PW5-1 | 13600 | 67 | 444 | 33 | 0 | 0 | 0 | 0 | 19852 | 83 | 423 | <200 |
| PW5-2 | 12350 | 58 | 448 | 26 | 0 | 0 | 0 | 0 | 18115 | 60 | 451 | <200 |
| PW5-3 | 12250 | 59 | 538 | 25 | 0 | 0 | 0 | 0 | 18080 | 0 | 802 | <200 |
| PW6-1 | 12650 | 64 | 517 | 2 | 0 | 0 | 0 | 0 | 17619 | 0 | 211 | <800 |
| PW6-2 | 12500 | 54 | 511 | 2 | 0 | 0 | 0 | 0 | 17193 | 0 | 287 | <800 |
| PW7-2 | 12300 | 47 | 522 | 24 | 0 | 0 | 0 | 0 | 19001 | 0 | 660 | <200 |

These produced water samples contained about 3-4 wt % NaCl, a trivial amount of potassium ions, and various degrees of hardness. Some had H₂S smell, suggesting the existence of active bacteria. The pH values of these water samples were usually close to 7, or they were adjusted with HCl or NaOH to near neutral (6.8-7.2) before water treatment and/or fluid preparation.

A series of experiments were conducted to identify the most likely cause of fluid failure in fracturing fluids comprising produced water. Various fracturing fluids (guar or guar derivative-based) were prepared using untreated or “as is” water samples and as treated samples.

Control example to screen Zr ions for disabling the hemicellulase enzyme breaker M2: Example Sample 1 (ES1) was a crosslinked guar fluid prepared with deionized (DI) water, 6.25 mL/L M1, 2.2 mL/L M10, and 2.5 mL/L M11. ES2 was also a crosslinked guar fluid prepared in the same way with DI water, M1, M10 and M11, but also included 0.75 mL/L of the hemicellulase enzyme breaker M2. ES3 was prepared with the same components as ES2 but began with the addition of the hemicellulase enzyme breaker M2 to the DI water, followed by the addition of 0.75 mL/L of an aqueous solution of zirconium acetate containing an equivalent of 7.1 wt % ZrO₂, and the treated water was then let stand for several hours before the application of the same crosslinked guar formula. All three fluids were tested at 52° C. with a Fann 50 viscometer.

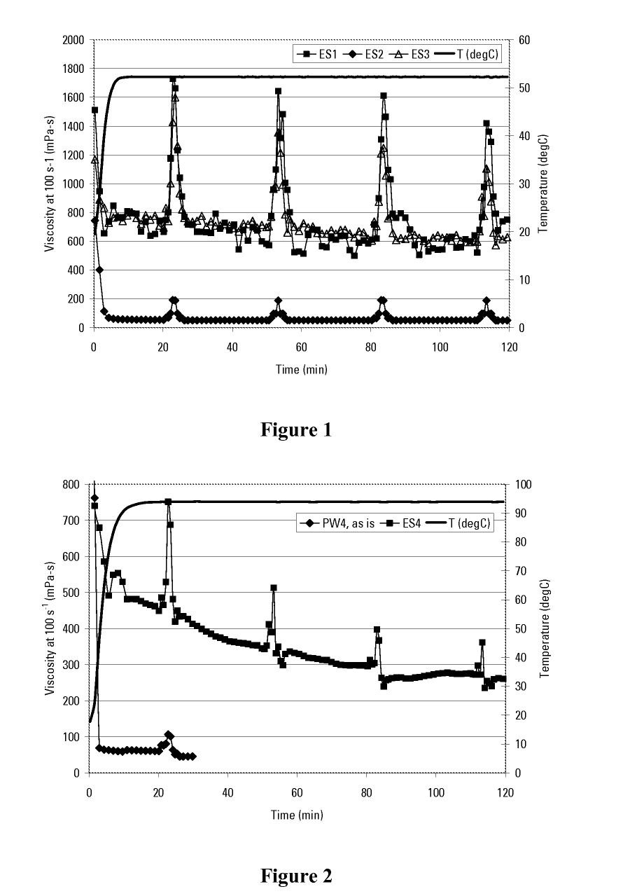

As shown in FIG. 1, the viscosity of ES1 stayed well above 100 cP for over 2 hours. ES2 with the enzymatic breaker M2 crashed quickly because M2 breaks down the guar polymer chains. But after treatment with the organo-zirconium, ES3 behaved nearly the same as ES1, indicating that the breaker M2 had been denatured or otherwise disabled by the organo-zirconium.

Example of produced water treated with zirconyl chloride: Produced water PW4 was treated with 0.36 mL/L of zirconyl chloride solution M14. The mixture was stirred and then let stand for 30 minutes or more. Gels comprising borate-crosslinked guar were prepared with 8.8 mL/L M1, 6.0 mL/L M10, and 2.5 mL/L M11, in both the untreated and the M14-treated PW4 produced water. The viscosities of the fluids were tested with a Fann 50 viscometer. As shown in FIG. 2, ES4 prepared from produced water treated with M14 showed good viscosity at 93° C., compared with the same gel made from the “as is” PW4 which exhibited a rapid viscosity loss.

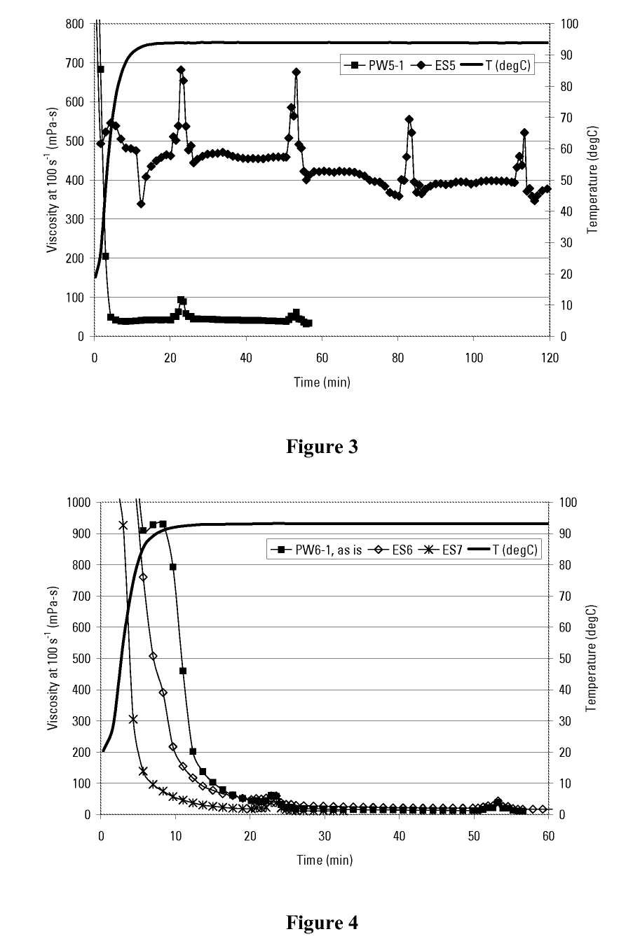

Example of produced water treated with zirconium tetrachloride (ZTC): Produced water PW5-1 was treated with 1 mL/L of an aqueous solution of ZTC (containing an equivalent of 7.0 wt % ZrO₂), stirred and then let stand for 1 day. Gels comprising borate-crosslinked guar were prepared with 8.8 mL/L M1, 6.0 mL/L M10 and 2.5 mL/L M11, using the treated (ES5) and untreated water (PW5-1, as is), and the viscosity of the fluids was tested with a Fann 50 viscometer at 93° C. As shown in FIG. 3, ES5 prepared from ZTC-treated PW5-1 showed much better viscosity, well above 100 cP at 93° C., compared with the same gel made from the untreated PW5-1. Similar gels prepared from 30 minutes to 2 or 3 days after treatment of the produced water with ZTC showed similar results.

The foregoing inorganic zirconium examples show that treatment time as short as 30 minutes was adequate for these zirconium compounds to completely disable bacteria and/or enzymes in the produced water. Extended treatment for up to several days before fluid preparation usually showed no obvious difference when compared with the fluids prepared from the produced water with the 30-minute treatment. The pH change of the produced water after treatment was typically less than 0.2.

Examples of produced water treated with other inorganic heavy metal ions: Gels of borate-crosslinked guar were prepared from 8.8 mL/L M1, 6.0 mL/L M10 and 2.5 mL/L M11, added to two samples of BaCl₂-treated PW6-1 produced water—0.28 g/L BaCl₂ in ES6 and 3.4 g/L BaCl₂ in ES7, followed by individual stirring for 30 minutes. As shown in FIG. 4, treatment with inorganic Ba ions did not seem to improve fluid viscosity at 93° C. compared to the untreated water PW6-1, suggesting that Ba²⁺ did not disable all bacteria/enzymes present. This finding is consistent with reports that some bacteria can reduce BaSO₄ to produce H₂S, which would not occur if Ba ions could have killed the bacteria. See, for example, “Sulfate-reducing bacteria release barium and radium from naturally occurring radioactive material in oil-field barite,” Geomicrobiology Journal, v. 18 (2), pp. 167-182, 2001). This suggests that Ba treatment may be useful when sulfate-reducing bacteria are not present.

Further, the treatment of produced water with CuCl₂ did not obviously improve the viscosity of similar gels compared with the same formulated gels prepared with the “as is” produced water. A possible explanation may be that the Cu²⁺ ions had been quickly precipitated out by the anions in the produced water before they could effectively disable bacteria and enzymes, suggesting that chelated copper and/or organo-copper compounds may have utility.

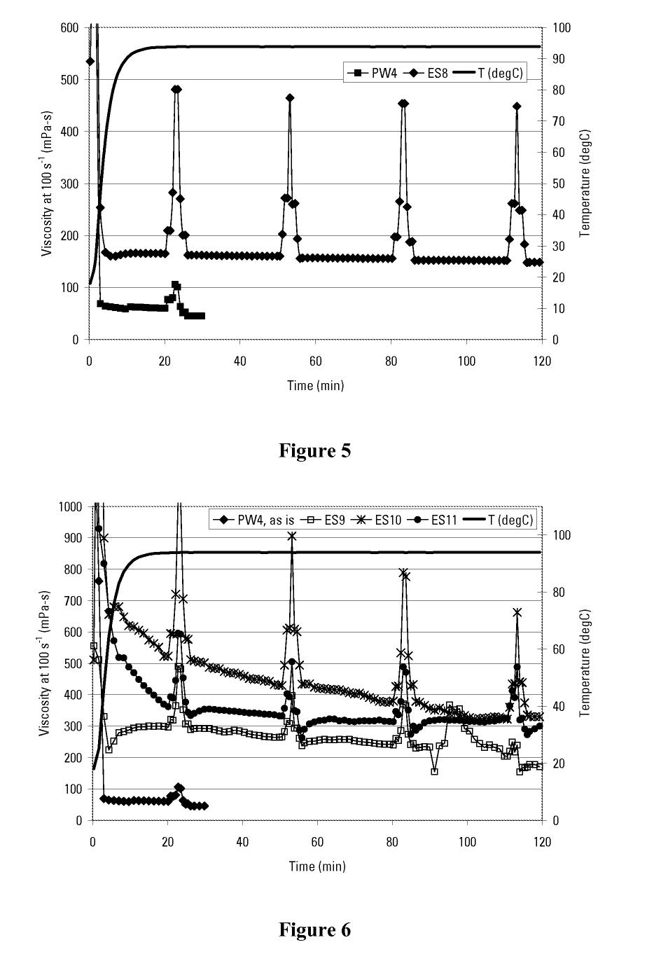

Examples of produced water treated with zirconium acetate (ZAD): Produced water PW4 was treated with 1 mL/L of the aqueous solution of zirconium acetate, dried (ZAD, solution containing an equivalent of 7.1% ZrO₂), and stirred and then let stand for 1 hour. Gels comprising borate-crosslinked guar made with 8.8 mL/L M1, 6.0 mL/L M10, and 2.5 mL/L M11, were then prepared from the treated (ES8) and untreated produced water (PW4, as is), and the viscosity of the fluids was tested with a Fann 50 viscometer at 93° C. As shown in FIG. 5, ES8 prepared from ZAD-treated produced water showed much better viscosity, compared with the same gel made from the “as is” PW4.

Examples of produced water treated with sodium zirconium lactate M8, triethanolamine zirconium M9 and pure sodium zirconium lactate: Produced water PW4 was treated with 0.5 mL/L either sodium zirconium lactate M8 or triethanolamine zirconium M9 (containing an equivalent of 7.1% ZrO₂), or with a solution of solid sodium zirconium lactate (SZL) at the same equivalent ZrO₂ concentration, stirred and then let stand for over 12 hours. Gels comprising borate-crosslinked guar made with 8.8 mL/L M1, 6.0 mL/L M10, and 2.5 mL/L M11, were then prepared from the treated (M9-ES9, M8-ES10, SZL-ES11) and untreated produced water (PW4, as is), and the viscosities of the fluids were tested with a Fann 50 viscometer at 93° C. As shown in FIG. 6, fluids prepared from PW4 pretreated with M9 (ES9), M8 (ES10), or SZL (ES11) showed similarly good viscosity at 93° C., whereas the fluid made with untreated PW4 failed rapidly.

Produced water PW6-2 was treated with 1 mL/L triethanolamine zirconium M9, stirred and then let stand for 12 hours. A gel comprising borate-crosslinked guar made with 6.3 mL/L M1, 6.0 mL/L M10, and 2.5 mL/L M11, was then prepared from the treated (ES12) and untreated produced water (PW6-2, as is), and the viscosities of the fluids were tested with a Fann 50 viscometer at 79° C. As shown in FIG. 7, the M9-treated produced water used to prepare ES12 resulted in good viscosity maintenance for over 2 hours, in contrast to the untreated PW6-2.

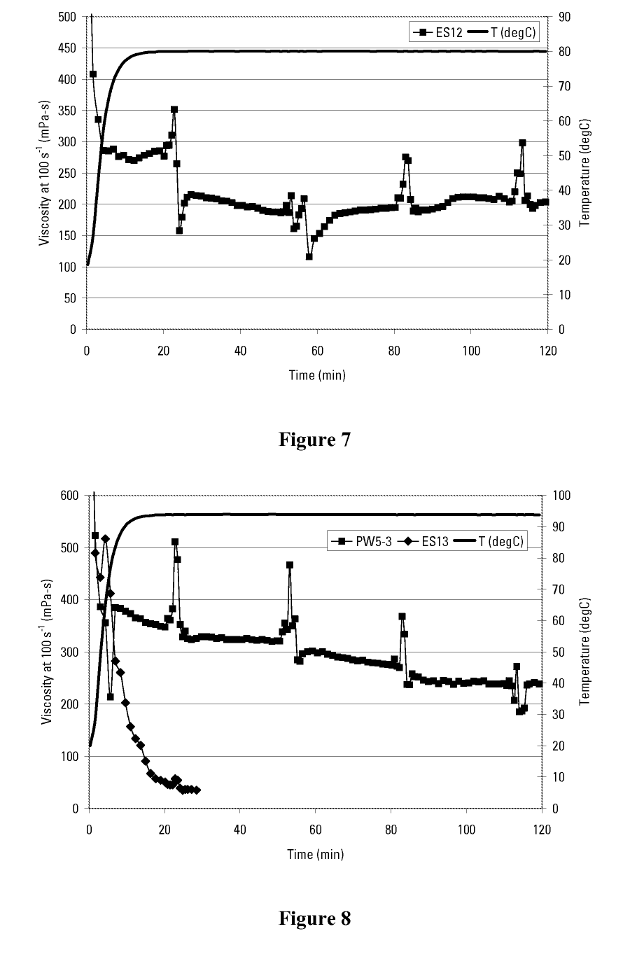

Produced water PW5-3 was treated with 1 mL/L of an aqueous solution of sodium zirconium lactate M8 (containing an equivalent of 7.1% ZrO₂), stirred and then let stand for 11 hours. A gel comprising borate-crosslinked guar made with 6.3 mL/L M1, 6.0 mL/L M10, 2.5 mL/L M11, and 0.38 mL/L M17, was then prepared from the treated (ES13) and untreated produced water (PW5-3, as is), and the viscosities of the fluids were tested with a Fann 50 viscometer at 93° C. As shown in FIG. 8, the M8-treated produced water used to prepare ES13 resulted in good viscosity maintenance for over 2 hours, in contrast to the untreated PW5-3.

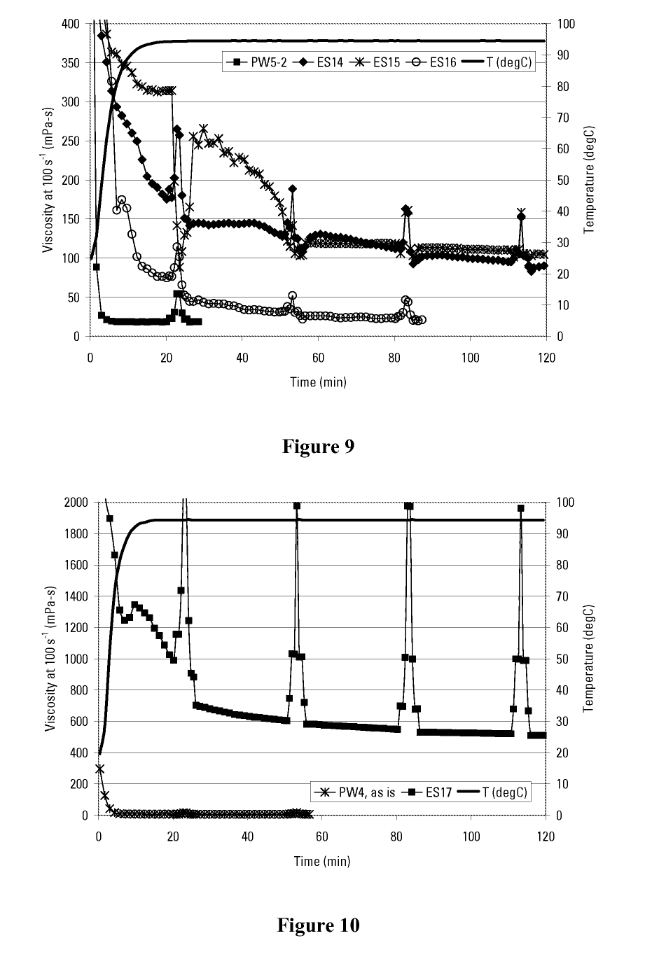

Produced water PW5-2 was treated with 0.5 (ES14), 1 (ES15) or 2 (ES16) mL/L triethanolamine zirconium M9, stirred and then let stand for 1 day. Gels comprising borate-crosslinked guar made with 6.25 mL/L M1, 4.24 mL/L M10, 2.50 mL/L M11, and 0.38 mL/L M17, were then prepared from the treated (ES14-16) and untreated produced water (PW5-2, as is), and the viscosities of the fluids were tested with a Fann 50 viscometer at 93° C. FIG. 9 shows viscosity profiles at 93° C. of gels comprising borate-crosslinked guar made with produced water (PW5-2, as is), and with produced water pretreated with 0.5 (ES14), 1 (ES15) or 2 (ES16) mL/L M9, showing the disabling of bacteria and/or enzymes by the pretreatment according to embodiments of the invention.

Produced water PW4 was treated with 0.5 mL/L of an aqueous solution of triethanolamine zirconium M9 and then let stand for 32 hours. A gel comprising a high-pH borate-crosslinked guar, made with 6.25 mL/L M1, 2.0 mL/L M5, 1.7 g/L M7, 2.5 mL/L M11, 0.66 g/L M13, and 3 mL/L M17, was then prepared from the treated (ES17) and untreated produced water (PW4, as is), and the viscosities of the fluids were tested with a Fann 50 viscometer at 93° C. As shown in FIG. 10, the produced water treated with M9 used to prepare ES17 resulted in good viscosity for over 2 hours, in contrast to the untreated PW4. Similar results (not shown) were obtained in similar gels using produced water pretreated with sodium zirconium lactate M8.

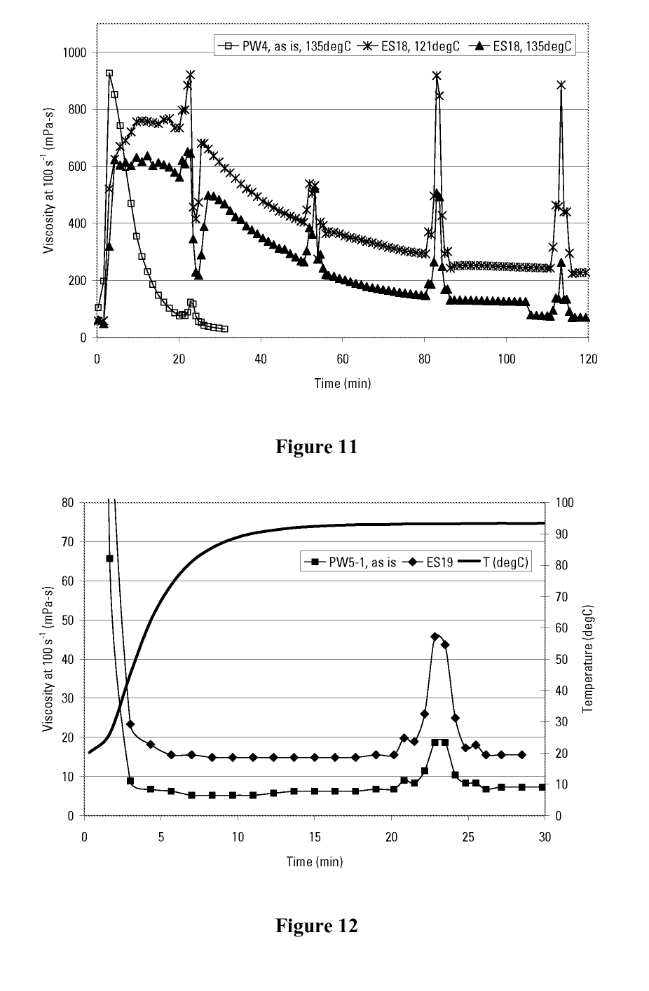

Produced water PW4 was treated with 0.5 mL/L sodium zirconium lactate M8 and then let stand for 24 hours. Gels comprising zirconate-crosslinked carboxymethylhydroxypropyl guar (CMHPG), made with 1.2 g/L M4, 0.79 mL/L M9, 9 mL/L M12, and pH adjusted with M16 to about 4, were then prepared from the treated (ES18) and untreated produced water (PW4, as is), and the viscosities of the fluids were tested with a Fann 50 viscometer at 121 and/or 135° C. As shown in FIG. 11, the M8-treated produced water used to prepare ES18 resulted in better viscosity maintenance than the same gel made from the untreated PW4. Similar results (not shown) were obtained in similar zirconate-crosslinked CMHPG gels using produced water pretreated with triethanolamine zirconium M9.

As shown above, and in other tests undertaken, produced water was effectively treated with either M8 or M9 at typical concentrations of 0.5 to 1.0 mL/L. Higher concentrations of the treatment such as 2 mL/L occasionally had adverse effects on polymer gelation, e.g., resulting in a fluid of many small gel domains with low viscosity, possibly due to the interaction between borate crosslinker and the remaining zirconium after the treatment. The pH change of the water after treatment was typically less than 0.2. There was also no consistent difference between treatment with M8 or M9. The treatment typically lasted for from several hours to 1 day. Extended treatment for up to 5 days usually showed no obvious difference. However, when the treatment lasted for only 15 minutes before the addition of the fluid formula, an adverse reaction, presumably between zirconium and the borate crosslinkers, usually occurred, possibly because the organo-zirconium had not been fully “consumed” away by bacteria and enzymes.

Compared with the inorganic zirconium compounds mentioned above, it generally took more time for organo-zirconium compounds tested to achieve the same treating result in produced water. The treatment with organo-zirconium compounds typically lasted for from several hours to 1 day. A combination of organic and inorganic zirconium compounds can thus be beneficial in the sense that the treating time of produced water can be flexible from 30 minutes to several days. No obvious difference was observed among organo-zirconium compound treatments lasting for from several hours (10 hours, for example) to several days (5 days, for example).

Examples of produced water treated with triethanolamine titanate: PW5-1 was treated with 1 mL/L of triethanolamine titanate M3 and allowed to stand for 1 day. A gel comprising a high-pH borate-crosslinked guar, made with 6.25 mL/L M1, 4.24 mL/L M10, 2.50 mL/L M11, and 0.38 mL/L M17, was prepared using the treated water (ES19). The same formula was also applied to the “as is” produced water without any treatment (PW5-1, as is). Viscosity measurements were carried out with a Fann 50 viscometer at 93° C. As seen in FIG. 12, triethanolamine titanate may not kill bacteria and/or denature enzymes in produced water under the test conditions. The viscosity of both treated and untreated PW5-1 quickly deteriorated to below 20 cP. The possible reason may be that ions of titanium, a relatively light element, do not possess the bacterium- and/or enzyme-disabling power at the test conditions as some heavy metal ions do.

Examples of fracture conductivity evaluation of fluids prepared with zirconium-treated produced water: Fracture conductivity evaluation was conducted to check if the produced water, treated with zirconium compounds and then used for fracturing fluid preparation, had any adverse effect on the fracture conductivity. The permeability of the proppant pack exposed to test fluid was measured using a conductivity apparatus. The apparatus comprised a 555 kN load press and a modified HASTELLOY API conductivity cell with a 77 cm² flow path. The temperature of the conductivity cell was controlled by heated platens contacting the sides of the cell and hot oil circulated through the pistons. Pressure transducers were used to measure the system pressure and the pressure drop across the length of the fracture. The transducers were plumbed with 3.2 mm lines and a digital caliper used to measure the fracture gap width. Syringe pumps were used to pump brine through the cell during flow-back and conductivity measurements. The pumps drew nitrogen-sparged 2 wt % KCl brine from a flowback reservoir. Before the brine entered the conductivity cell, it passed through a silica saturation system. Proppant pack conductivity tests were performed using 16 kg/m² of 20/40 mesh size sand, available from Unimin Corporation, at 93° C. and 28,000 kPa effective closure stress. A baseline conductivity test with the sand was performed without the fracturing fluid. A permeability of 50 D was observed after 20 hours of injecting 2 wt % KCl, which is lower than the PredictK2 data of 164 D. For comparison purposes, a baseline permeability of 50 D was used in this study.

The PW6-2 produced water was treated with 1 mL/L M9 for about 16 hours before fluid preparation. Borate-crosslinked guar fluids using tap water (as the control samples) and zirconium-treated produced water were similarly prepared except for the different clay stabilizing agent. Table 2 shows the amount of clay stabilizing agent and other ingredients in the fluid formulas prepared with tap water and zirconium-treated produced water.

TABLE 2

| | | | | Fluid made | |
|---|---|---|---|---|---|
| | | Fluid | | with Zr- | |
| | | made | | treated | |
| Material | | with tap | | produced | |
| designation | Descriptions | water | | water | |
| M1 | polysaccharide gums | 6 | mL/L | 6 | mL/L |
| | (PSG) polymer slurry | | | | |
| M11 | clay stabilizer and | — | | 2 | mL/L |
| | surfactant liquid blend | | | | |
| M15 | temporary clay stabilizer | 2 | mL/L | — | |
| M18 | non-emulsifying agent | 2 | mL/L | — | |
| M21 | borate crosslinker | 3 | mL/L | 3 | mL/L |
| M6 | encapsulated ammonium | 0.12 | g/L | 0.12 | g/L |
| | persulfate breaker | | | | |

A static leak off procedure was performed at 6900 kPa closure stress prior to the flowback period. Table 3 shows the results of the conductivity tests after 16 hours of continuous flowback. A conductivity of 104 md-m or 76% (a fluctuation of up to 20% is reasonable) retained permeability was observed for the fluid prepared with tap water, whereas 58% retained permeability was observed for the fluid prepared with the zirconium-treated produced water. Based on these results, the fluid prepared with the zirconium-treated produced water did not significantly affect the proppant pack cleanup as the retained permeability of 58% falls within the range of 76%±20%, the retained permeability of the control. An optimized fluid formulation or increased breaker concentration can further improve the proppant pack cleanup for fluids prepared with zirconium-treated produced water.

TABLE 3

| Tests | Descriptions | Data |
|---|---|---|
| Fluid made | permeability (Darcy) | 38 |
| with tap water, | frac gap, mm | 2.738 |
| with 0.12 g/L | conductivity, md-m | 104 |
| M6 | retained permeability | 76 |
| | (%) | |
| Fluid made | permeability (Darcy) | 29 |
| with produced | frac gap, mm | 2.807 |
| water, with | conductivity, md-m | 81 |
| 0.12 g/L M6 | retained permeability | 58 |
| | (%) | |
| Baseline | permeability (Darcy) | 50 |
| | frac gap, mm | 2.609 |
| | conductivity, md-m | 129 |

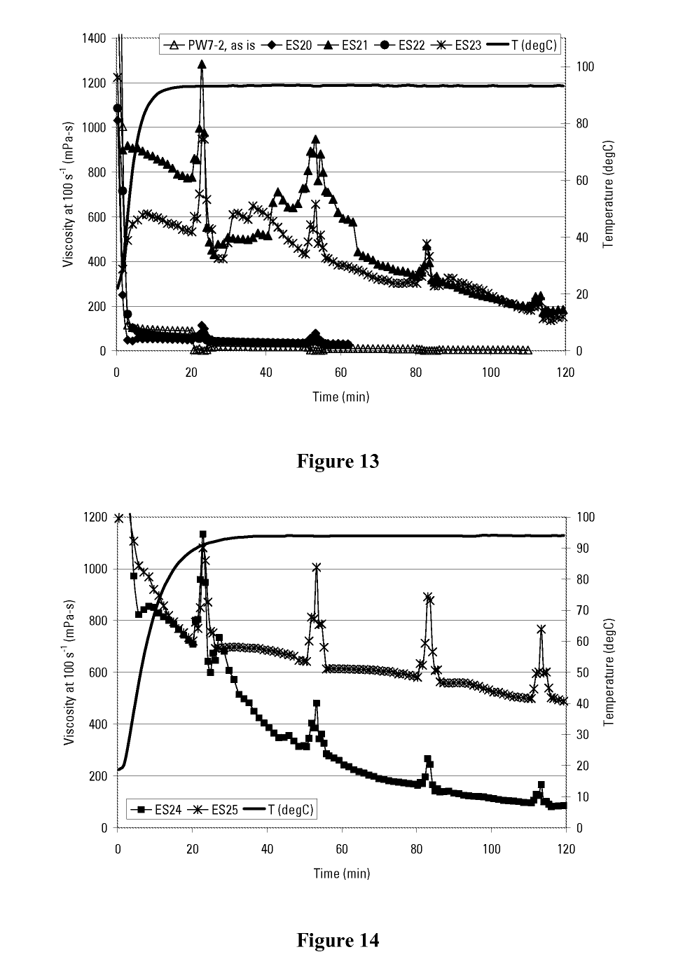

Examples showing synergy between organo-zirconium compounds and bactericides: Produced water PW7-2 was treated as follows one day before fluid preparation: (1) no treatment (used to prepare fluid PW7-2, as is); (2) with 0.2 mL/L bactericide M19 (used in fluid ES20); (3) with 0.2 mL/L bactericide M19 and 0.5 mL/L organo-zirconium M8 (used in fluid ES21); (4) with 0.05 mL/L M20 (ES22); and (5) with 0.05 mL/L M20 and 0.5 mL/L organo-zirconium M8 (used in fluid ES23). The borate-crosslinked guar gels were prepared using the treated or untreated PW7-2 with 8.8 mL/L M1, 6 mL/L M10, and 2 mL/L M15, and viscosity measured at 93° C. with A Fann 50 viscometer. As shown in FIG. 13, the untreated water (PW7-2, as is), or treatment with only bactericide M19 (ES20) or M20 (ES22), did not form stable fluids at 93° C. On the other hand, the combination of organo-zirconium M8 with bactericide M19 (ES21) or M20 (ES23), showed good viscosity at 93° C. for at least 2 hours. These findings suggest that the combination of bactericides and zirconium compounds disable both bacteria and enzymes, enabling the guar polymer fluids to retain their viscosity for a longer period of time.

Examples showing synergy between inorganic zirconium compounds and bactericides: Produced water PW7-2 was treated as follows one day before fluid preparation: (1) with a combination of 0.2 mL/L M19 and 0.18 mL/L M14 (used in ES24); and (2) with a combination of 0.2 mL/L M19 and 0.36 mL/L M14 (used in ES25). Borate-crosslinked guar gels were prepared using the treated water with 8.8 mL/L M1, 6 mL/L M10, and 2 mL/L M15, and viscosity measured at 93° C. with a Fann 50 viscometer. As shown in FIG. 14, the viscosity curve for ES24 stayed above 100 cP for about 2 hours at 93° C. When the amount of M14 pretreatment was increased to 0.36 mL/L in ES25, the viscosity profile appeared more robust.

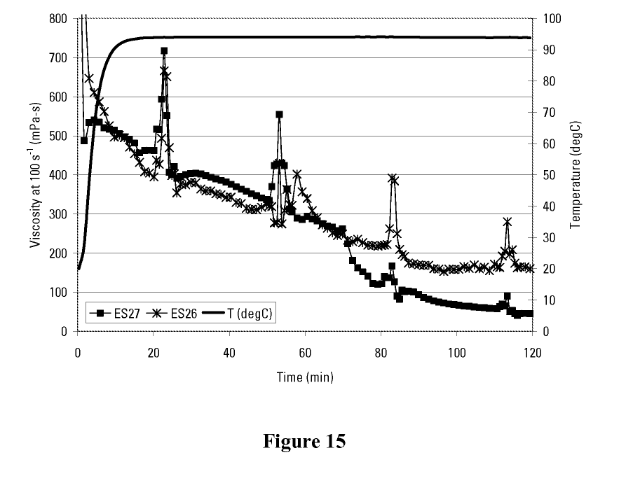

Produced water PW7-2 was treated as follows one day before fluid preparation: (1) with a combination of 0.2 mL/L M19 and 1 mL/L aqueous solution of 13 wt % ZTC (used in ES26); and (2) with a combination of 0.2 mL/L M19 and 0.5 mL/L aqueous solution of 13 wt % ZTC (used in ES27). Borate-crosslinked guar gels were prepared using the treated water with 8.8 mL/L M1, 6 mL/L M10, and 2 mL/L M15, and viscosity measured at 93° C. with a Fann 50 viscometer. As shown in FIG. 15, the viscosity curve for ES26 stayed above 100 cP for about 2 hours at 93° C. When the amount of ZTC pretreatment was reduced to 0.5 mL/L in ES27, the viscosity stayed above 100 cP for about 1.5 hours at 93° C.

Bactericides including M19 and M20 can show long term bacteria-killing/suppressing effects when added in produced water. The addition of these bactericides alone, however, does not always guarantee the stability of the fracturing fluids prepared from produced water. This can be because the normal dosage of these bactericides can be insufficient to disable both bacteria and enzymes, and the latter can continue to decompose fracturing fluids after the elimination of bacteria. This problem can be solved by adding zirconium compounds and bactericides simultaneously to produced water.

The samples all shared one characteristic: when using the samples “as is”: the respective fluid viscosities of the fracturing fluids obtained quickly deteriorated at the designed working temperatures. The test data demonstrate the degradation of the polysaccharide or polysaccharide derivatives by the bacteria and/or related enzymes in the untreated produced water, and the effectiveness of embodiments to disable the bacteria and/or enzymes.

The foregoing disclosure and description of the invention is illustrative and explanatory thereof and it can be readily appreciated by those skilled in the art that various changes in the size, shape and materials, as well as in the details of the illustrated construction or combinations of the elements described herein can be made without departing from the spirit of the invention.

What is claimed is:

1. A method of inhibiting enzymes in an aqueous medium for viscosification, comprising:
contacting the aqueous medium with a denaturant comprising a metal; and
thereafter mixing a gelling agent in the aqueous medium to form a viscosified fluid.

2. The method of claim 1 wherein the aqueous medium comprises oilfield produced water.

3. (canceled)

4. (canceled)

5. (canceled)

6. The method of claim 5 wherein the metal comprises an inorganic zirconium compound selected from the group consisting of zirconium nitrate, zirconyl chloride, zirconium phosphate, zirconium potassium chloride, zirconium potassium fluoride, zirconium potassium sulfate, zirconium pyrophosphate, zirconium sulfate, zirconium tetrachloride, zirconium tetrafluoride, zirconium tetrabromide, zirconium tetraiodide, zirconyl carbonate, zirconyl hydroxynitrate, zirconyl sulfate, zirconium complexed with amino acids, zirconium complexed with phosphonic acids, hydrates thereof and combinations thereof.

7. The method of claim 6 wherein the mixing is within 0.5 to 120 hours of the contacting.

8. The method of claim 6 wherein the aqueous medium can be free of detectable sulfide.

9. (canceled)

10. The method of claim 1 wherein the metal comprises an organo-zirconium compound selected from the group consisting of zirconium acetate, zirconyl acetate, zirconium acetylacetonate, zirconium glycolate, zirconium lactate, zirconium naphthenate, sodium zirconium lactate, triethanolamine zirconium, zirconium propionate, hydrates thereof and combinations thereof.

11. The method of claim 10 wherein the mixing is within 2 to 72 hours of the contacting.

12. The method of claim 1 wherein the metal comprises an inorganic zirconium compound in combination with an organo-zirconium compound.

13. The method of claim 1 wherein the denaturant further comprises a bactericide.

14. (canceled)

15. (canceled)

16. (canceled)

17. (canceled)

18. (canceled)

19. The method of claim 10 wherein the aqueous medium can comprise detectable sulfide.

20. The method of claim 1 wherein the contacting comprises admixing the zirconium compound in the aqueous medium at a concentration from 1 to 2000 ppm by weight of the aqueous medium.

21. The method of claim 1 wherein the contacting comprises admixing the zirconium metal compound in the aqueous medium at a concentration from 5 to 500 ppm by weight of the aqueous medium.

22. The method of claim 1 wherein the gelling agent comprises a polysaccharide.

23. The method of claim 22 wherein the gelling agent is crosslinked.

24. The method of claim 1 wherein the gelling agent comprises a viscoelastic surfactant system.

25. The method of claim 1 further comprising injecting the viscosified fluid into a subterranean formation adjacent a well bore.

26. The method of claim 25 further comprising breaking the injected fluid and producing fluid from the formation through the well bore.

27. The method of claim 26 wherein the viscosified fluid comprises proppant and the injection forms a conductive fracture in the formation held open by the proppant.

28. A well treating fluid comprising the viscosified fluid produced from the method of claim 1.

29. A well treating fluid comprising:
oilfield produced water;
a denaturant comprising a metal compound; and
a gelling agent in an amount effective to viscosify the fluid.

30. (canceled)

31. (canceled)

32. The well treating fluid of claim 29 wherein the metal compound is selected from the group consisting of zirconium nitrate, zirconyl chloride, zirconium phosphate, zirconium potassium chloride, zirconium potassium fluoride, zirconium potassium sulfate, zirconium pyrophosphate, zirconium sulfate, zirconium tetrachloride, zirconium tetrafluoride, zirconium tetrabromide, zirconium tetraiodide, zirconyl carbonate, zirconyl hydroxynitrate, zirconyl sulfate, hydrates thereof and combinations thereof.

33. (canceled)

34. The well treating fluid of claim 29 wherein the metal compound comprises organo-zirconium.

35. The well treating fluid of claim 29 wherein the metal compound is selected from the group consisting of zirconium acetate, zirconyl acetate, zirconium acetylacetonate, zirconium glycolate, zirconium lactate, zirconium naphthenate, sodium zirconium lactate, triethanolamine zirconium, zirconium propionate, hydrates thereof and combinations thereof.

36. (canceled)

37. The well treating fluid of claim 29 further comprising a bactericide.

38. The well treating fluid of claim 30 wherein the metal compound comprises a combination of an inorganic zirconium compound and an organo-zirconium compound.

39.-59. (canceled)
